(19) United States
(12) Patent Application Publication
(10) Pub. No.: US 2004/0189735 A1
(43) Pub. Date: Sep. 30, 2004

(54) Ink jet head cleaning apparatus and ink jet recording apparatus

(75) Inventors: Hidekazu Ishii, Tagata-gun (JP); Hideaki Nishida, Tagata-gun (JP); Kazuhisa Kimura, Hiratsuka-shi (JP); Hideyuki Akaba, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Toshiba Tec Kabushika Kaisha, Tokyo (JP)

(21) Appl. No.: 10/395,960

(22) Filed: Mar. 24, 2003

(51) Int. Cl. B41J 2/165

(52) U.S. Cl. 347/22; 347/30; 347/33

(57) ABSTRACT

An ink jet head cleaning apparatus of the present invention comprises a flexible contact member and a driving unit. The flexible contact member is mounted in a position where its top end comes into contact with a nozzle face of an ink jet head having the nozzle face provided with outlets for discharging ink in a form of droplets, and is movable along the nozzle face. On the other hand, the driving unit functions to correlatively move the ink jet head and the contact member. The top end of the contact member is divided into a plurality of sections in a direction orthogonal to the direction of its movement. Thus, a foreign substance holding on the nozzle face can be removed completely from the nozzle face by means of the wipe blade. Furthermore, the growth of the foreign substance can be restrained. It is therefore possible to prevent deterioration of ink discharge stability and straight discharge of ink.

### BACKGROUND OF THE INVENTION

1. Field of the Invention

The present invention relates to an ink jet head cleaning apparatus for cleaning an ink jet head which has a nozzle face provided with nozzle outlets for discharging droplets of ink from the outlets and an ink head recording apparatus having the ink jet head.

2. Discussion of the Background

The ink jet recording apparatus is provided with an ink jet head having a nozzle face in which outlets are formed to discharge droplets of ink from nozzles to a recording medium. The apparatus, therefore, functions to record images on the recording medium by means of the ink jet head. In such an ink jet recording apparatus, because the ink jet head approaches the recording medium during recording operation, the nozzle face of the ink jet head is sometimes smeared with sprayed ink resulting from the impingement of ink droplets on the recording medium. Particularly, in the case of an on-demand type ink jet recording apparatus, a little energy is used to discharge ink droplets from the nozzles. Furthermore, since the ink jet head is mounted about several millimeters off from the recording medium, the nozzle face is likely to be smeared with the sprayed ink, resulting in occurrence of clogged nozzles. If the clogging of nozzles once occurs, it is difficult to eliminate nozzle clogging because a little pressure is used for ink discharge from the nozzles.

Therefore, to prevent or eliminate the nozzle clogging, there has been proposed a technology to suck ink from the nozzles during non-recording operation. Even in the case when the sucking technology is adopted, however, the ink sometimes remains on the nozzle face after sucking, smearing the nozzle face. Such smearing of the nozzle face will allow fibers of the recording medium, dirt and dust to hold on the nozzle face, resulting in clogging of the nozzles during a long-time use of the ink jet head. The nozzle clogging will become a factor to deteriorate ink discharge stability and straight discharge of ink. To prevent such a deterioration, there has been proposed a cleaning technology (Refer to Japanese Patent Publication No. 06-071904) to wipe the nozzle face with a flat flexible wipe blade in order to remove ink remaining on the nozzle face.

However, extraneous matters holding on the nozzle face may be ink, ink pigments remaining after the evaporation of ink solvents, fibers of the recording medium, and, furthermore, a mixture of all of these extraneous matters. These extraneous matters are sometimes hard to remove by the use of a flexible wipe blade. In such a case, it is a general practice to perform a regular maintenance, besides the wiping operation, to thereby remove the extraneous matters. However, in case there remains an extraneous matter (hereinafter called the “foreign substance”) which can not be removed by the wipe blade during a period until a subsequent maintenance, the foreign substance will gradually grow larger by uniting with ink and fibers remaining around, finally resulting in deteriorated ink discharge stability and straight discharge of ink. Therefore, it is important to prevent the growth of the foreign substances holding on the nozzle face during a period until the subsequent maintenance.

Now, FIG. 9A is an enlarged longitudinal sectional side view schematically showing a nozzle face 102 of an ink jet head 101 before wiping by a conventional wipe blade 100. FIG. 9B is an enlarged longitudinal sectional side view schematically showing the nozzle face 102 of the ink jet head 101 during wiping by the conventional wipe blade 100. And FIG. 9C is an enlarged longitudinal sectional side view schematically showing the nozzle face 102 of the ink jet head 101 after wiping by the conventional wipe blade 100.

As shown in FIG. 9A, a foreign substance F1 that can not be removed by the wipe blade 100 adheres heaping up on the nozzle face 102 of the ink jet head 110. In addition, a foreign substance F2 that can be removed by the wipe blade 100 also attaches on the nozzle face 102. When the conventional wipe blade 100 is operated to wipe the nozzle face 102 in such a state, the top end of the wipe blade 100, as shown in FIG. 9B, strikes on the foreign substance F1, causing a clearance to occur between the wipe blade 100 and the nozzle face 102. Therefore, the foreign substance F2 that has flowed into the clearance or the foreign substance F2 that is present in the clearance is not removed, remaining on the nozzle face 102 as shown in FIG. 9C.

It is impossible for the flexible wipe blade 100 to fully uniformly be in contact with the nozzle face 102. There is, therefore, apprehension that non-uniform wiping will occur. Generally, the nozzle face 102 is made ink repellent so that the ink will be repelled. If the ink-repellent nozzle face 102 is wiped, easy-to-suck large droplets of ink are especially spread thin on the nozzle face 102 in a fine form of droplets of ink which is hard to suck. The fine ink droplets are prone to dry soon; therefore, if left as spread, the droplets will be stuck on the nozzle face 102, resulting in impaired ink repellency of the nozzle face 102. Besides, new ink will gather thereat, growing finally to be a factor to deteriorate the ink discharge stability and straight discharge of ink. Particularly, fine ink droplets are hard to suck, and therefore it is difficult to completely remove the fine ink droplets. Furthermore, the wipe blade 100, being formed of a flexible material, is likely to force the foreign substance F2 on the nozzle face 102 back into the nozzle during wiping operation. Particularly, if the foreign substance such as stickier ink or fiber is pushed back into the nozzle, the nozzle will be clogged or deformed. Therefore, nozzle clogging will become a factor to deteriorate the ink discharge stability, and also nozzle deformation will be a cause to deteriorate straight discharge of ink.

### SUMMARY OF THE INVENTION

It is, therefore, an object of the present invention to provide an ink jet head cleaning apparatus and an ink jet recording apparatus which can prevent the deterioration of ink discharge stability and straight discharge of ink.

The object of the present invention is accomplished by a new ink jet head cleaning apparatus and ink jet recording apparatus of the invention.

Therefore, the new ink jet head cleaning apparatus of the present invention is comprised of a flexible contact member which is mounted in a position where the top end thereof comes into contact with a nozzle face of an ink jet head having the nozzle face provided with outlets for discharging ink in a form of droplets, and is movable along the nozzle face; and a driving unit which correlatively moves the ink jet head and the contact member. The top end of the contact member is divided into a plurality of sections in a direction orthogonal to the direction of its movement.

Therefore, the new ink jet recording apparatus of the present invention is comprised of an ink jet head having a nozzle face provided with outlets for discharging ink in a form of droplets; a flexible contact member which is mounted in a position where the top end thereof comes into contact with the nozzle face, and is movable along the nozzle face; and a driving unit for correlatively moving the ink jet head and the contact member. The leading end of the contact member is divided into a plurality of sections in a direction orthogonal to the direction of its movement.

Therefore, the new ink jet head cleaning apparatus of the present invention is comprised of a contact member which is mounted in a position where it comes into contact with a nozzle face of an ink jet head which has the nozzle face provided with outlets to discharge ink in a form of droplets and is movable along the nozzle face; a suction section for sucking ink droplets holding on the nozzle face; and a driving unit which correlatively moves the ink jet head and the contact member. The contact member is provided on the contact surface which is in contact with the nozzle face and has groove portions extending in the direction of movement.

Therefore, the new ink jet recording apparatus of the present invention is comprised of an ink jet head having a nozzle face provided with outlets from which ink is discharged in a form of droplets; a contact member mounted in a position where it comes into contact with the nozzle face and moves along the nozzle face; a suction section which sucks ink droplets attached on the nozzle face; and a first driving unit for correlatively moving the ink jet head and the contact member. The contact member is provided with groove portions on the contact surface which comes into contact with the nozzle face, extending in the direction of its movement.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a front view schematically showing an ink jet recording apparatus according to the first embodiment of the present invention;

FIG. 2 is an enlarged longitudinal sectional side view schematically showing a wipe blade according to the first embodiment of the present invention;

FIG. 3 is a block diagram schematically showing an electric connection of each part used in the ink jet recording apparatus according to the first embodiment of the present invention;

FIG. 4A is an enlarged longitudinal sectional side view schematically showing a nozzle face of an ink jet head before wiping by a wipe blade according to the first embodiment of the present invention;

FIG. 4B is an enlarged longitudinal sectional side view schematically showing the nozzle face of the ink jet head during wiping by the wipe blade according to the first embodiment of the present invention;

FIG. 4C is an enlarged longitudinal sectional side view schematically showing the nozzle face of the ink jet head after wiping by the wipe blade according to the first embodiment of the present invention;

FIG. 5 is a front view schematically showing the ink jet recording apparatus according to the second embodiment of the present invention;

FIG. 6 is an enlarged longitudinal sectional side view schematically showing the wipe blade of the ink jet apparatus according to the second embodiment of the present invention;

FIG. 7 is a schematic block diagram showing an electric connection of each part of the ink jet recording apparatus according to the second embodiment of the present invention;

FIG. 8A is a perspective outside view schematically showing the nozzle face of the ink jet head before wiping by the wipe blade according to the second embodiment of the present invention;

FIG. 8B is a perspective outside view schematically showing the nozzle face of the ink jet head after wiping by the wipe blade according to the second embodiment of the present invention;

FIG. 9A is an enlarged longitudinal sectional side view schematically showing the nozzle face of the ink jet head before wiping by a conventional wipe blade;

FIG. 9B is an enlarged longitudinal sectional side view schematically showing the nozzle face of the ink jet head during wiping by the conventional wipe blade; and

FIG. 9C is an enlarged longitudinal sectional side view schematically showing the nozzle face of the ink jet head after wiping by the conventional wipe blade.

### DETAILED DESCRIPTION OF THE PREFERRED EMBODIMENTS

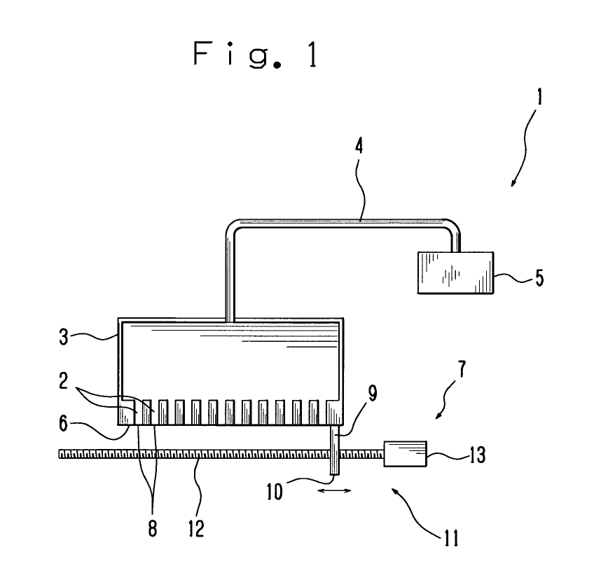

The first embodiment of the present invention will now be described with reference to FIG. 1 to FIG. 4. The present embodiment gives an example of application of the ink jet head cleaning apparatus to the ink jet recording apparatus 1.

FIG. 1 is a front view schematically showing the ink jet recording apparatus 1 of the present embodiment. The ink jet recording apparatus 1 is provided with an ink jet head 3 which discharges ink in a form of droplets from a nozzle 2, an ink tank 5 for holding ink which is connected to the ink jet head 3 through an ink supply line 4, and a cleaning section 7 for cleaning a nozzle face 6 of the ink jet head 3. Furthermore, the ink jet recording apparatus 1 is also provided with a conveyor (not shown) which successively feeds out and carries the sheet, which is a recording medium, in the sub-scanning direction, and a carriage (not shown) for carrying in the main scanning direction the ink jet head 3 mounted thereon.

The ink jet head 3 is provided with a plurality of nozzles 2 arranged nearly in a straight line. The plurality of nozzles 2 are arranged in a straight line and also arranged in some cases slightly deviated from the straight line. On the nozzle face 6, therefore, outlets 8 of the nozzles 2 are formed nearly in the straight line. That is, the ink jet head 3 is so constituted as to discharge ink in a form of droplets from the outlets 8 of the nozzle face 6.

As the ink jet head 3, used is a piezoelectric type ink jet head 3 fitted with a piezoelectric-crystal element or a thermal ink jet type ink jet head 3 using a heating element.

The cleaning section 7 is comprised of a wipe blade 10 which is mounted in a position where its top end 9 comes into contact with the nozzle face 6 of the ink jet head 3, and is movable along the nozzle face 6 (e.g., in the direction of arrangement of the nozzles 2 (outlets 8)), and a driving unit 11 for moving the wipe blade 10 in the direction of arrangement of the nozzles 2. The wipe blade 10 stated above functions as a contact member.

The driving unit 11 is comprised of a guide screw 12 for moving to guide the wipe blade 10 in the direction of arrangement of the plurality of nozzles 2, and a driving motor 13 for driving the guide screw 12.

The wipe blade 10, holding its top end 9 in contact with the nozzle face 6, is driven by the driving unit 11 in the direction of arrangement of the plurality of nozzles 2, thus wiping the nozzle face 6 of the ink jet head 3.

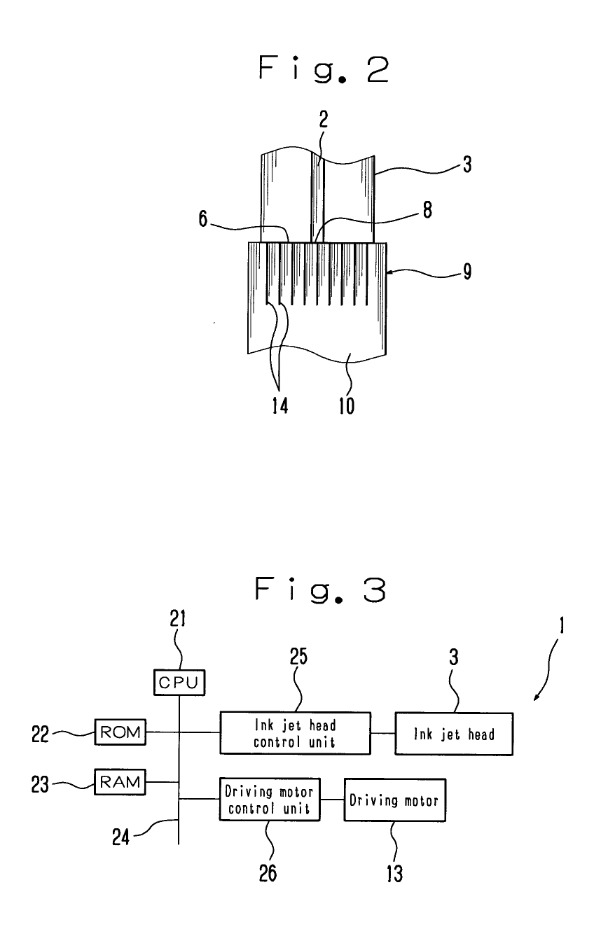

FIG. 2 is an enlarged longitudinal sectional side view schematically showing the wipe blade 10 of the ink jet recording apparatus 1 of the present embodiment. The wipe blade 10 is formed flat of a flexible material, e.g., rubber. The top end 9 of the wipe blade 10 is divided into a plurality of sections along the nozzle face 6, that is, nearly in a direction orthogonal to the direction of movement of the wipe blade 10. Therefore, the wipe blade 10 has a plurality of slits 14 in the contact surface which comes into contact with the nozzle face 6, extending in the direction of movement of the wipe blade 10.

FIG. 3 is a block diagram schematically showing electric connection of each part of the ink jet recording apparatus 1 according to the present embodiment. The ink jet recording apparatus 1 has a built-in controller 20. The controller 20 includes a CPU (central processing unit) 21 which centrally controls each part, a ROM (read only memory) 22 which stores various kinds of control programs to be run by the CPU 21, and a RAM (random access memory) 23 which functions as a work area of the CPU 21. The CPU, the ROM and the RAM are connected by a bus line 24. To the CPU 21, the ink jet head 3 is connected through an ink jet head control unit 25. Furthermore, the driving motor 13 is connected through a driving motor control unit 26. Furthermore, to the CPU 21, a conveyor (not shown) and a carriage (not shown) are connected through the drive control unit (not shown).

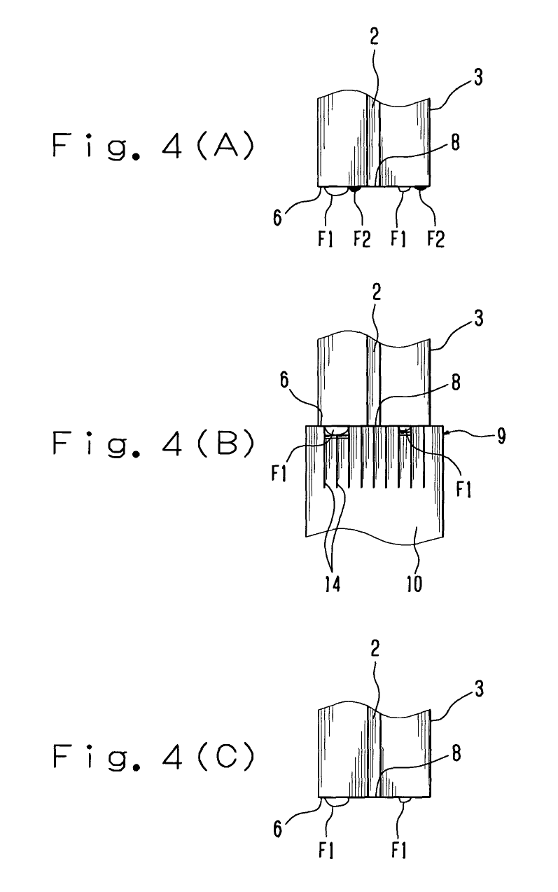

In such a constitution as described above, the cleaning operation of the cleaning portion 7 for cleaning the nozzle face 6 of the ink jet head 3 of the ink jet recording apparatus 1 will be explained by referring to FIG. 4. FIG. 4A is an enlarged longitudinal sectional side view schematically showing the nozzle face 6 of the ink jet head 3 before wiping by the wipe blade 10 of the present embodiment. FIG. 4B is an enlarged longitudinal sectional side view schematically showing the nozzle face 6 of the ink jet head 3 during wiping by the wipe blade 10 of the present embodiment. And FIG. 4C is an enlarged longitudinal sectional side view schematically showing the nozzle face 6 of the ink jet head 3 after wiping by the wipe blade 10 of the present embodiment.

As shown in FIG. 4A, the foreign substance F1 (e.g., a dry solidified mixture of ink drops and fibers) that can not be removed by the use of the wipe plate 9 attaches heaping up on the nozzle face 6 of the ink jet head 3, and in addition, the foreign substance 2 (e.g., wet ink drops) that can be removed by the use of the wipe plate 9 also attaches on the nozzle face 6. In such a state, the ink jet recording apparatus 1 drives to control the cleaning section 7 during non-recording operation of the ink jet head 3. That is, the ink jet recording apparatus 1 drives to control the driving motor 13 to turn the guide screw 12, moving the wipe blade 10 while holding the top end 9 in contact with the nozzle face 6. Thus the cleaning operation (i.e., the wiping operation) is performed. At this time, as shown in FIG. 4B, the top end 9 of the wipe blade 10 is divided into a plurality of sections. Therefore, a part of the top end 9 rides on the foreign substance F1, while the other part of the top end 9 is in a desirable state of contact with the nozzle face 6. Consequently, there will not occur such a large clearance that allows the foreign substance F2 to flow in between the wipe blade 10 and the nozzle face 6. As shown in FIG. 4C, therefore, the foreign substance F2 is removed completely from the nozzle face 6 by the wipe blade 10. The foreign substance F1 that can not be removed by the wipe blade 10 remains on the nozzle face 6 but can be removed by regular maintenance jobs. The foreign substance F1 is present on the nozzle face 6 until the maintenance job is performed. However, the foreign substance F2 will not grow large because it is removed completely from the nozzle face 6 by the wipe blade 10 by every wiping operation. Therefore, the foreign substance F1 will not become a factor to deteriorate ink discharge stability and straight discharge of ink.

In the present embodiment, the nozzle face 6 is wiped with the wipe blade 10 having the top end 9 divided into a plurality of sections. Thus, not only the foreign substance F2 can be removed completely from the nozzle face 6 by the wipe blade 10 if there remains the foreign substance F1 on the nozzle face 6 but the growth of the foreign substance F1 can be restrained. Therefore, it is possible to prevent ink discharge stability and straight discharge of ink, and consequently is possible to prevent occurrence of defective printing.

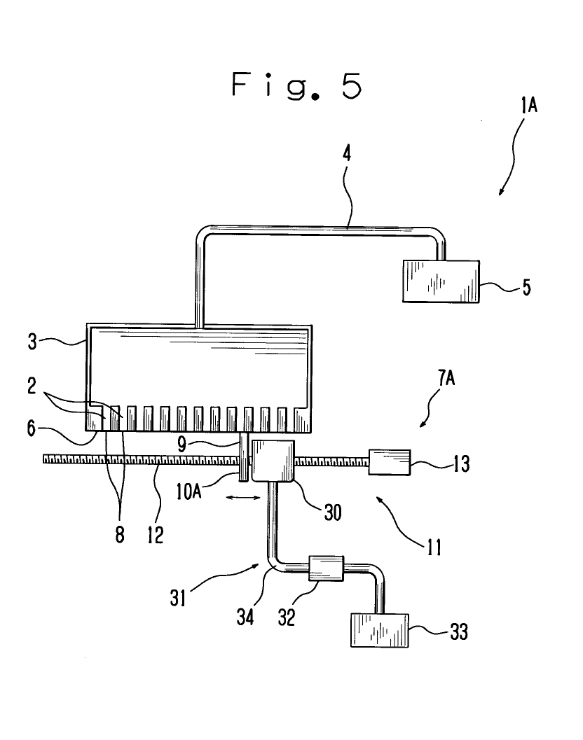

The second embodiment of the present invention will be explained with reference to FIG. 5 to FIG. 8. It should be noted that the same members as those in the first embodiment are designated by the same reference numerals. The present embodiment is an example of application of the ink jet head cleaning apparatus to the ink jet recording apparatus 1A.

FIG. 5 is a front view schematically showing the ink jet recording apparatus 1A of the present embodiment. The ink jet recording apparatus 1A is provided with the ink jet head 3 which discharges ink from the nozzles 2 in a form of droplets to the recording medium, the ink tank 5 for holding ink which is connected to the ink jet head 3 through the ink supply line 4, and the cleaning section 7A for cleaning the nozzle 2 and nozzle face 6 of the ink jet head 3.

The ink jet head 3 has a plurality of nozzles 2 formed nearly in a straight line. The plurality of nozzles 2 are arranged in a straight line and in some cases slightly deviated from the straight line. On the nozzle face 6, therefore, the outlets 8 of the nozzles 2 are formed nearly in the straight line. That is, the ink jet head 3 is so constituted that ink can be discharged in a form of droplets from the outlets 8 of the nozzle face 6.

As the ink jet head 3, there is used the piezoelectric type ink jet head 3 provided with a piezoelectric-crystal element or the thermal ink jet type ink jet head 3 with a heating element.

The cleaning section 7A is comprised of the wipe blade 10A which is mounted in a position where its top end 9 comes into contact with the nozzle face 6 of the ink jet head 3, and is movable along the nozzle face 6 (e.g., in the direction of arrangement of the nozzles 2 (outlets 8)) and which sucks ink from the nozzles 2 and the nozzle face 6, a suction section 31 which has a suction head 30 positioned oppositely to the nozzle face 6, movably along the nozzle face 6 (e.g., in the direction of arrangement of the nozzles 2 (outlets 8)), and the driving unit 11 for moving the wipe blade 10A and the suction head 30 in the direction of arrangement of the plurality of nozzles 2. The wipe blade 10A stated above functions as a contact member. The suction section 31 is positioned upstream of the wipe blade 10A in the direction of suction and movement, but is not limited thereto.

The driving unit 11 is comprised of the guide screw 12 which moves to guide the wipe blade 10A in the direction of arrangement of the plurality of nozzles 2, and the driving motor 13 for driving to turn the guide screw 12. Here, the driving unit 11 functions as the first and second driving units. According to the present embodiment, the wipe blade 10A and the suction head 30 are moved simultaneously by means of the driving unit 11 alone. However, it should be noticed that the driving means is not limited to the driving unit 11. For example, a couple of driving units 11 may be employed to separately move the wipe blade 10A and the suction head 30.

The wipe blade 10A is moved by the driving unit 11 in the direction of arrangement of the plurality of nozzles 2, with the top end 9 kept in contact with the nozzle face 6, thereby wiping the nozzle face 6 of the ink jet head 3.

The suction section 31 is constituted by connecting to the suction head 30 which covers a part of the plurality of outlets 8 in the ink jet head 3, a suction pump 32 which produces a suction force for sucking ink from the nozzle 2 and the nozzle face 6, and a waste ink tank 33 for holding sucked waste ink through an ink discharge line 34. As the suction head 30 is moved by the driving unit 11 in the direction of arrangement of the nozzles 2, the suction section 31 sucks ink from all the nozzles 2 and the nozzle face 6 of the ink jet head 3 after wiping operation is completed by the wipe blade 10A. In the present embodiment, the suction head 30 is so constituted as to cover a part of the plurality of nozzles 2, but is not limited to the constitution. For example, the suction head 30 may be so constituted as to cover all of the nozzles 2 to thereby hold the nozzles from moving.

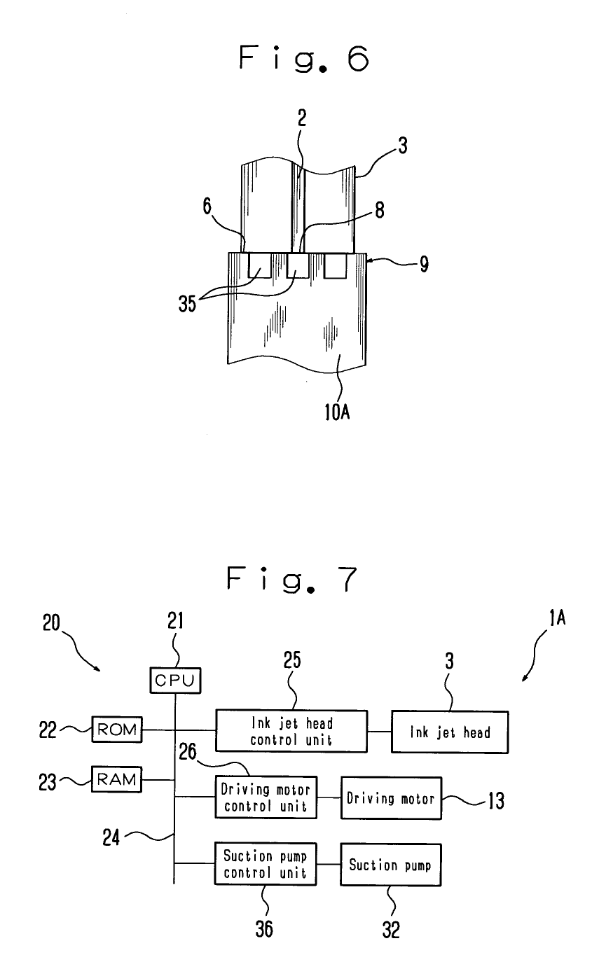

FIG. 6 is an enlarged longitudinal sectional side view schematically showing the wipe blade 10A of the ink jet recording apparatus 1A according to the present embodiment. The wipe blade 10A is formed flat of a flexible material, e.g., rubber. In the contact surface of the wipe blade 10A which comes into contact with the nozzle face 6, a plurality of groove portions 35 are formed extending in the direction of travel of the wipe blade 10A. Therefore, the wipe blade 10A is provided with the plurality of groove portions 35 in the contact surface which comes into contact with the nozzle face 6, extending in the direction of its movement. One of the plurality of groove portions 35 is located in a position opposite to the nozzle 2.

It should be noted that in the present embodiment, the plurality of groove portions 35 are formed at a regular spacing but are not limited thereto, and may be formed at a different spacing for example. Furthermore, the plurality of groove portions 35 are formed to the same width, but are not limited to the width. The groove portions 35 may be formed to different widths for example. Furthermore, the plurality of groove portions 35 are all formed square in cross section, but are not limited thereto; that is, the groove portions 35 may be formed triangular in cross section and each of the groove portions 35 may be formed in different cross section. Furthermore, the groove portions 35 are formed plural but are not limited thereto. The number of the groove portion 35 may be one for example.

FIG. 7 is a block diagram schematically showing the electric connection of each part of the ink jet recording apparatus 1A according to the present embodiment. The ink jet recording apparatus 1A has a built-in controller 20. The controller 20 comprises a CPU (central processing unit) 21 which centrally controls each part, a ROM (read only memory) 22 which stores various kinds of control programs to be run by the CPU 21, and a RAM (random access memory) 23 which functions as a work area of the CPU 21; the CPU, the ROM and the RAM being connected by a bus line 24. To the CPU 21, the ink jet head 3 is connected through an ink jet head control unit 25. Furthermore, the driving motor 13 is connected through the driving motor control unit 26 and the suction pump 32 is connected through the suction pump control unit 36.

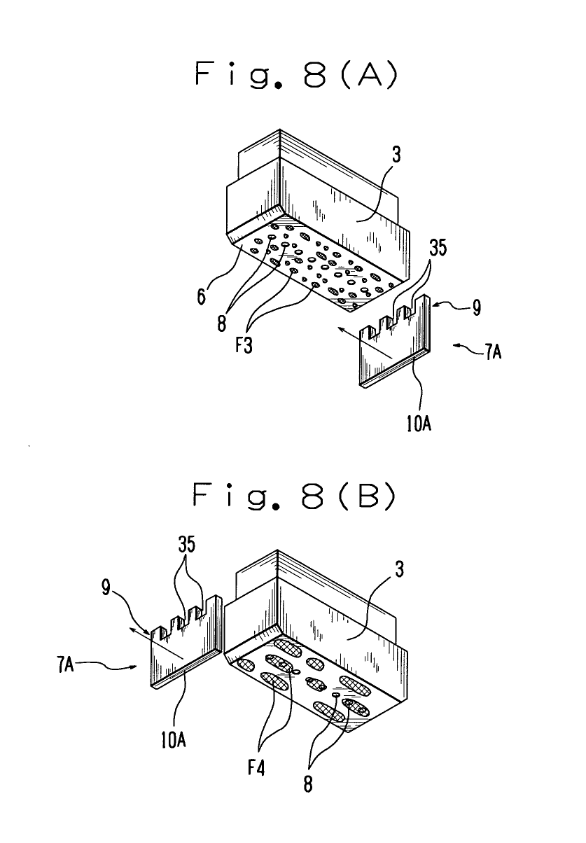

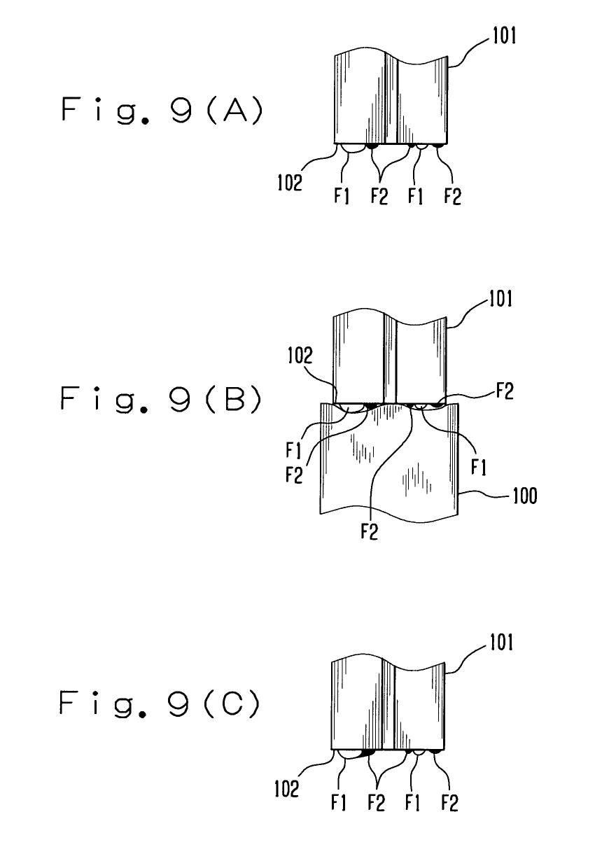

In the constitution described above, the cleaning operation of the cleaning section 7A for cleaning the nozzle face 6 of the ink jet head 3 of the ink jet recording apparatus 1A will be explained by referring to FIG. 8. FIG. 8A is a perspective outside view schematically showing the nozzle face 6 of the ink jet head 3 before wiping by the use of the wipe blade 10A according to the present embodiment. FIG. 8B is an enlarged perspective outside view schematically showing the nozzle face 6 of the ink jet head 3 after wiping by the wipe blade 10A according to the present embodiment.

As shown in FIG. 8A, fine hard-to-suck ink droplets F3 (an extraneous matter) adheres scatteringly on the nozzle face 6. In this state, the ink jet recording apparatus 1A drives to control the cleaning section 7A during the non-recording operation of the ink jet head 3. That is, the ink jet recording apparatus 1A drives the driving motor 13 to turn the guide screw 12, thereby moving the wipe blade 10A and the suction head 30 of the suction section 31. Thus, the top end 9 of the wipe blade 10A travels while in contact with the nozzle face 6; and the suction section 31 also travels while sucking ink from the nozzle 2 and the nozzle face 6, thereby performing the cleaning operation (e.g., wiping operation and suction operation). At this time, as shown in FIG. 8B, fine extraneous matters F3 that have come into contact with the top end 9 of the wipe blade 10A move to collect at the groove portions 35 of the wipe blade 10A, forming an ink accumulation extending in the direction of movement of the wipe blade 10A. The ink accumulation is easily sucked away by the suction section 31.

In the present embodiment, the nozzle face 6 is wiped by the wipe blade 10A having the groove portions 35 in the top end 9, thereby collecting the fine ink droplets scattered on the nozzle face 6. The ink droplets thus collected become an easy-to-suck large drops of ink (ink accumulation), thereby enabling the suction section 31 to reliably suck the large ink drops from the nozzle face 6. Therefore the fine ink droplets are removed completely from the nozzle face 6, preventing deterioration of ink discharge stability and straight discharge of ink. Consequently, the occurrence of defective printing can be prevented.

Furthermore, in the present embodiment, one of the plurality of groove portions 35 is positioned oppositely to the nozzle 2, so that the top end 9 of the wipe blade 10A will not move on the nozzles 2 in contact with the outlets 8 of the nozzles 2. Therefore, it is possible to prevent entrance of foreign substances (adherent ink and fibers) into the nozzles 2 and consequently to prevent clogging of the nozzles 2.

Furthermore, in the present embodiment, the wipe blade 10A has the plurality of groove portions 35 in the contact surface thereof which comes into contact with the nozzle face 6. That is, a required number of groove portions 35 are cut in accordance with the size of the contact surface, so that fine ink droplets scattered on the nozzle surface 6 can be efficiently collected. Furthermore, the wipe blade 10A and the suction head 30 are moved by one driving unit 11, and therefore it is possible to realize space saving and cost reduction as compared with the case of provision of two driving units 11.

Furthermore, in each embodiment described above, the cleaning section 7, 7A is moved by the driving unit 11 in relation to the ink jet head 3, but it should be noticed that the driving means is not limited to the driving unit 11; the cleaning section 7, 7A and the ink jet head 3 are required to correlatively move. For example, the ink jet head 3 may be so constituted as to move in relation to the cleaning section 7, 7A.

Obviously, numerous modifications and variations of the present invention are possible in the light of the above teachings. It is therefore to be understood that within the scope of the appended claims, the invention may be practiced otherwise than as specifically described herein.

What is claimed is:

1. An ink jet head cleaning apparatus, comprising:
a flexible contact member which is mounted in a position where a top end thereof comes into contact with a nozzle face of an ink jet head having the nozzle face provided with outlets for discharging ink in a form of droplets, and is movable along the nozzle face; and
a driving unit which correlatively moves the ink jet head and the contact member,
wherein the top of the contact member is divided into a plurality of sections in a direction orthogonal to the direction of its movement.

2. An ink jet recording apparatus, comprising:
an ink jet head having a nozzle face provided with outlets, and discharging ink from the outlets in a form of droplets;
a flexible contact member which is mounted in a position where a top end thereof comes into contact with the nozzle face and is movable along the nozzle face; and
a driving unit for correlatively moving the ink jet head and the contact member,
wherein the top end of the contact member is divided into a plurality of sections in a direction orthogonal to the direction of its movement.

3. An ink jet head cleaning apparatus, comprising:
a contact member which is positioned in contact with a nozzle face of an ink jet head having the nozzle face provided with outlets to discharge ink in a form of droplets, and is movable along the nozzle face;
a suction section for sucking ink droplets holding on the nozzle face; and
a first driving unit which correlatively moves the ink jet head and the contact member,
wherein the contact member has groove portions in the contact surface which comes into contact with the nozzle face, extending in the direction of its movement.

4. An ink jet head cleaning apparatus according to claim 3, wherein the plurality of outlets are formed in a straight line; and
the groove portions are provided in a position opposite to the outlets.

5. An ink jet cleaning apparatus according to claim 3, wherein the plurality of groove portions are provided.

6. An ink jet cleaning apparatus according to claim 4, wherein the plurality of groove portions are provided.

7. An ink jet head cleaning apparatus according to claim 3, wherein the plurality of outlets are provided; and
the suction section has a suction head covering a part of the plurality of outlets, and furthermore is comprised of a second driving unit which correlatively moves the ink jet head and the suction head.

8. An ink jet head cleaning apparatus according to claim 7, wherein the first driving unit and the second driving unit are commonly usable.

9. An ink jet recording apparatus, comprising:
an ink jet head having a nozzle face provided with outlets to discharge ink in a form of droplets from the outlets;
a contact member which is positioned in contact with the nozzle face and movable along the nozzle face;
a suction section for sucking ink droplets holding on the nozzle face; and
a first driving unit for correlatively moving the ink jet head and the contact member,
wherein the contact member has groove portions in the contact surface being in contact with the nozzle face, extending in the direction of its movement.

10. An ink jet recording apparatus according to claim 9, wherein the plurality of outlets are formed in a straight line; and the groove portions are positioned oppositely to the outlets.

11. An ink jet recording apparatus according to claim 9, wherein the plurality of groove portions are provided.

12. An ink jet recording apparatus according to claim 10, wherein the plurality of groove portions are provided.

13. An ink jet recording apparatus according to claim 9, wherein the plurality of outlets are provided; and
the suction section has a suction head covering a part of the plurality of outlets, and furthermore is comprised of a second driving unit for correlatively moving the ink jet head and the suction head.

14. An ink jet recording apparatus according to claim 13, wherein the first driving unit and the second driving unit are commonly usable.
